(19) United States
(12) Patent Application Publication
(10) Pub. No.: US 2022/0405426 A1
(43) Pub. Date: Dec. 22, 2022

(54) WORKFLOW MANAGEMENT

(71) Applicant: Hewlett-Packard Development Company, L.P., Spring, TX (US)

(72) Inventors: Remy Husson, Bristol (GB); Helen Balinsky, Bristol (GB)

(73) Assignee: Hewlett-Packard Development Company, L.P., Spring, TX (US)

(21) Appl. No.: 17/770,069

(22) PCT Filed: Oct. 31, 2019
(86) PCT No.: PCT/US2019/059044

§ 371 Date: Apr. 19, 2022

(51) Int. Cl. G06F 21/64; G06Q 10/06; H04L 9/32; G06F 16/23

(52) U.S. Cl. CPC G06F 21/64; G06Q 10/0633; H04L 9/3239; G06F 16/2358; H04L 9/50

(57) ABSTRACT

In an example there is provided a method for certifying transactions of a workflow for a workflow comprising a set of transactions and a permitted order of execution of transactions. The method comprises generating verification data in response to a request from a client to certify a transaction of the workflow on the basis of a secure ledger where the verification data certifies the validity of the secure ledger. The method further comprises communicating the verification data to the client. The secure ledger is determined on the basis of workflow transactions.

### BACKGROUND

Workflows are ubiquitous in commercial and business environments. A workflow comprises a sequence of orchestrated and repeatable patterns of activities or tasks. Management of workflows allow businesses to systematically organize resources and streamline processes. Detailed records of tasks executed in a workflow may be maintained as part of a workflow management process. A workflow can be queried at a later date to verify that tasks have properly been executed in the workflow according to the correct order of execution.

### BRIEF DESCRIPTION OF THE DRAWINGS

FIG. 1 shows an apparatus according to an example.

FIG. 2 shows a block diagram of a method for certifying transactions of a workflow according to an example.

FIG. 3 is a schematic diagram showing a workflow template according to an example.

FIG. 4A is a schematic diagram showing a subtree of a workflow template according to an example.

FIG. 4B is a schematic diagram showing a subtree of a workflow template according to an example.

FIG. 5 is a schematic diagram showing a workflow template according to an example.

FIG. 6 is a schematic diagram showing a workflow.

FIG. 7 is a schematic diagram showing a subtree of a workflow template according to an example.

FIG. 8 shows a processor associated with a memory and comprising instructions for certifying transactions of a workflow on a computing device.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In recent years, secure ledger or “blockchain” technology has become more prevalent. A secure ledger can be a decentralized, distributed digital ledger, which may be public, that is used to record transactions across multiple nodes. Ledgers are used in a wide range of applications. Secure ledgers can be used to provide guarantees that certain tasks have been executed according to a well-defined process. They may be implemented using cryptographic tools such as digital signatures and hash functions. These tools can be used to provide parties with assurances that transactions have occurred according to data stored in the ledger.

In examples, a ledger comprises a series of blocks of data. An initial “genesis block” may comprise data that represents the initialization of a process or protocol. Subsequent blocks in the series are generated on the basis of previous blocks and new or additional inputs. This creates a chain of dependencies between the blocks. In particular, a record in the secure ledger cannot be altered retroactively, without the alteration of all subsequent blocks.

A secure ledger, constructed in this way, provides an immutable record of transactions which cannot be tampered with by an adversary. Ledgers digitise and simplify many processes which would have previously used a trusted third-party to verify.

Ledgers are used in a wide variety of contexts. According to examples, secure ledgers can be used in conjunction with other technology to implement workflows securely. A “workflow” in the context of the present disclosure, comprises a set of allowed transactions between one or more parties, together with a well-defined order of execution for transactions. A “workflow instance” is a particular set of transactions that occur according to a desired order of execution.

A workflow may be implemented in a secure ledger using a workflow template data structure that defines how to encode workflow step into the ledger. According to examples described herein, each transaction of a workflow references a predetermined address of the workflow template data structure. The workflow template data structure allows data to be written into the ledger as transactions of the workflow are executed. The template provides a placeholder for data to be incorporated into blocks of the ledger such that an immutable record of transactions may be generated.

In the context of the methods and systems described herein, a workflow may be executed using, for example, a smart contract. A smart contract is a protocol that is used to digitally facilitate, verify, or enforce the negotiation or performance of a contract. Smart contracts allow the performance of credible transactions without third parties. These transactions are trackable and irreversible.

In the context of performing workflows, a smart contract may be used to enforce workflow rules and write data to the secure ledger according to addresses defined in the workflow template. In some cases, another application may be used in conjunction with a smart contract which facilitates data read and write operations into the secure ledger.

A party may wish to query the secure ledger to determine whether a particular transaction of the workflow has occurred or not. A party, in general, cannot know for certain whether the values stored in the secure ledger can be trusted.

A secure ledger in the public domain may be distributed among a group of nodes of a peer-to-peer network. Security guarantees for public ledgers are provided for by group consensus and the distributed nature of the ledger across the nodes. In order to trust data queried from a secure ledger, a querying party either needs to run a full node themselves storing the secure ledger, or trust another entity to store the secure ledger securely.

In other examples, a secure ledger may be private. In such a case the client maybe not authorized to get access to the entire ledger. In some examples, clients cannot access data due to hardware limitations on the client side. If a client is unable or not allowed to run or trust a full secure ledger node, current secure ledger technologies do not provide guarantees for clients' queries in relation to remote untrusted ledgers. Additionally, confidentiality may prevent clients from accessing the whole ledger state. This makes verifying the integrity of the ledger state over time more challenging.

In some cases, a client may still be able to verify the integrity and validity of the most recent block of a secure ledger. However, they cannot read the whole state and verify smart contract executions. This can lead to attacks that allow an adversary to manipulate the content of the ledger state when a client queries it.

For example, an adversary may be able to generate a parallel history: copies of the secure ledger state are made, with each copy representing a different version of transactions. It is then possible for an adversary to choose which version of the content to return whenever a query is made, while still being able to prove that it is contained in the state.

In another kind of attack, an adversary can perform a last-minute state switch: when a query is made, a new block of the secure ledger is produced that changes the state to a desired value to deceive the client. It can then be returned while proving it is in that state, and then changed back on the secure ledger to its previous state one block later.

In a third example, an adversary can present an alternate history by using old blocks from the secure ledger: different versions of a response to a potential query can be spread out over time allowing the adversary to return a response of their choosing to a query.

The methods and systems described herein are used to provide assertions and guarantees to a client about information stored in a secure ledger for a workflow. The client cannot or may not verify some or all of the secure ledger. These methods can be used even when the querying client has no prior knowledge about the secure ledger apart from the block, and without requiring the querying party to store or remember any other information.

In the methods and systems described herein a workflow instance is collected in a workflow template data structure which is a dedicated ordered data structure in the secure ledger. Each workflow transaction is recorded in this data structure. In some cases, data relating to the workflow transaction is also recorded outside of the data structure. A client may query the secure ledger in relation to transactions that have supposedly occurred as part of a real workflow.

The client is provided with a response to their query. The response they receive is unique, complete and immutable over time. Uniqueness guarantees that there is one valid answer for a specific query. Completeness guarantees that all information relevant to a query is provided and is in correct order. Immutability guarantees the result of a query is independent of when the query was made. These assurances are provided without exposing information about other instances of the same workflow or other workflows recorded in the same ledger, and without exposing smart contract logic of another workflow.

The methods and systems described herein use specific state structures and a series of proofs, to provide strong guarantees about the data queried while maintaining confidentiality of the rest of the state of the secure ledger. In some examples, cryptographic proofs of knowledge are used to provide computationally secure proofs of statements relating to data stored in the secure ledger.

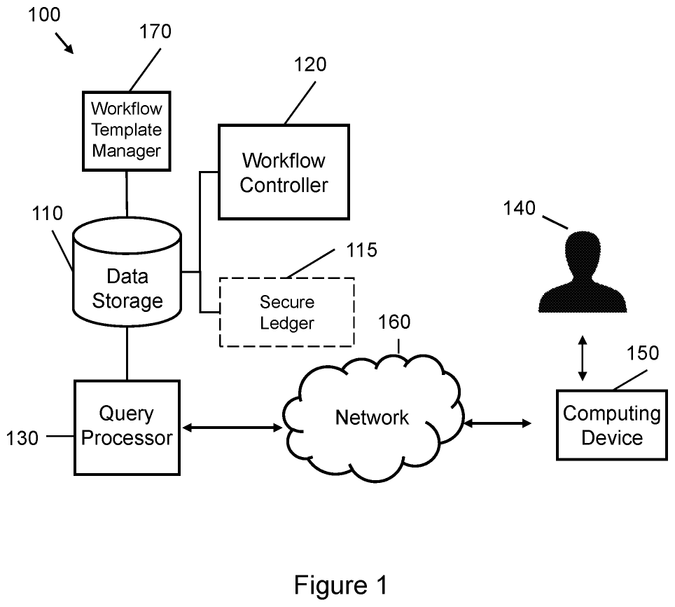

FIG. 1 is a schematic diagram showing an apparatus 100 according to an example. The apparatus 100 shown in FIG. 1 may be used to in conjunction with the other methods and systems described herein.

The apparatus 100 comprises a data storage 110. The data storage 110 is arranged to store secure ledger 115. According to examples, the secure ledger comprises a record of a history of transactions of the workflow. Herein, the secure ledger 115 comprises at least the data blocks of a secure ledger, together with address information of a workflow template data structure which specifies how transactions of the workflow are recorded in the secure ledger. The secure ledger 115 is determined on the basis of transactions of the workflow being executed. According to examples described herein, a workflow is encoded such that each transaction of the workflow is assigned a pre-determined entry in the workflow template data structure.

In FIG. 1, the data storage 110 is shown as a single entity. The data storage 110 may be implemented in a storage unit such as a server, or personal computer. In other examples the data storage 110 is implemented across multiple physical data storage entities in a distributed fashion. In some cases, one or more of those entities are publicly accessible. In some examples, the content of the secure ledger is publicly accessible over a network. In other cases, all or part of the secure ledger is private or is controlled by an access control policy.

The data storage 110 is communicatively coupled to a workflow controller 120. The workflow controller 120 is arranged to update and manage the entries in the workflow template data structure as transactions of the workflow are executed. This may include operations such as writing new data into the workflow template data structure, reading data from the workflow template, computing values associated to transactions such as hash values, and updating addresses in memory of where data is stored according to the secure ledger.

In some examples, the workflow controller 120 is arranged to update the secure ledger 115 on the basis of a smart contract. As previously described, a smart contract is a program that may be implemented to enforce workflow rules and write data to the secure ledger.

The apparatus 100 shown in FIG. 1 further comprises a query processor 130. The query processor 130 is communicatively coupled to the data storage 110. The query processor 130 can access data stored on the secure ledger in data storage 110. The query processor 120 is arranged to process queries relating to transactions that occur as part of a workflow instance.

According to examples, processing a query comprises accessing secure ledger 115. The entries of the secure ledger 115 that are accessed will depend on the nature of the query. In some cases, the query processor 120 accesses data from a previous state on a previous block of the ledger, to demonstrate that a certain transaction occurred at a previous point in time, and that the present state of the ledger is the correct state.

In response to the query, the query processor 120 is arranged to derive a query response on the basis of the secure ledger 115. As will be described in more detail, the query response is in some cases, a short proof of knowledge to prove particular statements about data that is recorded in the secure ledger 115.

In FIG. 1, the query processor 120 is arranged to communicate with a querying party 140 across a network 160. The network 160 shown in FIG. 1, is for example, a private local network such as a local area network (LAN). In other examples, the network 160 is a public network such as the internet. In the example shown in FIG. 1, the querying party 140 communicates with the query processor 130 using a device 150.

In some cases, the device 150 may have limited or no ability to access the secure ledger 115 stored in data storage 110 directly. In other examples, where the ledger is public, the device 150 can access data stored in data storage 110 but cannot store data directly. The query processor is arranged to communicate query response to the device 150 via network 160 in response to queries from the querying party 140.

The apparatus 100 comprises a comprising a workflow template manager 170. The workflow template manager 170 is communicatively coupled to the data storage 110 and workflow controller 120. The workflow template manager 170 is arranged to generate a workflow template data structure for a workflow. The workflow template data structure encodes workflow instances to a secure ledger.

According to examples described herein the workflow template manager 170 is arranged to assign a unique address to transactions of a workflow instance, such that data associated to the secure ledger 115 that is written into the workflow template data structure when a transaction is executed, is written in at a specific location according to the address in a deterministic fashion. This prevents several versions or histories of the same thing being placed in different locations of the workflow template data structure.

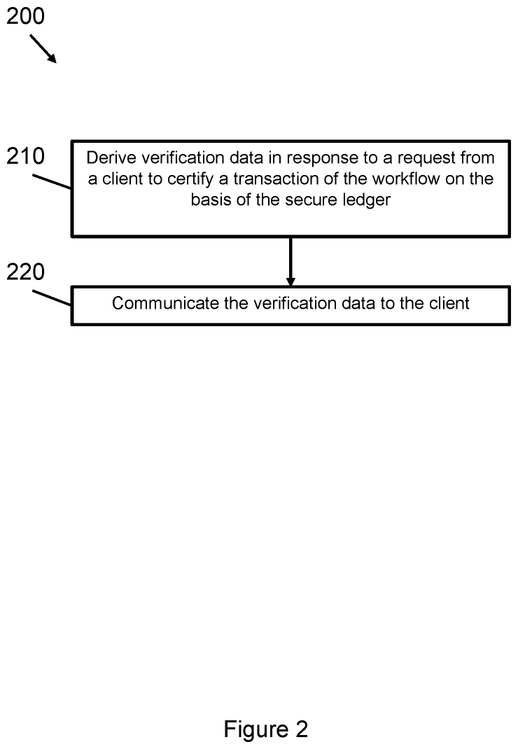

FIG. 2 is a block diagram showing a method 200 for certifying transactions of a workflow for a workflow comprising a set of transactions and permitted order of execution of transactions, according to an example. The method 200 may be implemented in conjunction with the other methods and systems described herein. In particular, the method 200 may be implemented on the apparatus 100 shown in FIG. 1.

In FIG. 2, the method 200 is implemented on a workflow which is encoded as a workflow template data structure in the secure ledger. Each transaction of the workflow is assigned a pre-determined entry in the workflow template data structure, and the secure ledger 115 is determined on the basis of transactions of the workflow being executed. In some cases, the secure ledger data is determined on the basis of values of a cryptographically secure hash function. In some cases, the hash values are hash values of state data associated to the workflow. According to examples, the state data may be associate with a global state of a workflow.

At block 210, verification data is derived on the basis of the secure ledger. The verification data certifies the validity of the secure ledger. When the method 200 is implemented on the apparatus 100 shown in FIG. 1, block 210 is implemented at the query processor 130. In some cases, deriving verification data on the basis of secure ledger, comprises generating verification data that certifies the validity of the secure ledger for the state of the secure ledger before, during and/or after a transaction of the workflow has occurred. In that case, the verification data certifies validity of secure ledger across the whole history of the workflow from before a transaction has occurred to its current state.

At block 220, the verification data is communicated to the client. When the method 200 is implemented on the apparatus 100 shown in FIG. 1, block 220 is implemented at the query processor 130. The verification data may be communicated over the network 160.

According to examples described herein, the verification data may comprise a cryptographic proof of knowledge such as a zero-knowledge proof. Zero-knowledge proofs allow a party to prove to a verifier 140 that a statement is true, without revealing any information beyond the validity of the statement itself. In the present context, such a cryptographic proof is used in circumstances where the content of the secure ledger is private. The verification data comprises proofs of statements relating to data that is written into the workflow template data structure. These proofs are short with no further communication with the querying party 140 after the verification data is communicated to the party.

According to examples, once the verification data has been communicated, the client receives verification data in response to a query and verifies the validity of the of the secure ledger on the basis of the verification data. In another case, the actual verification process is performed by trusted third party that communicates to the client that the secure ledger has been verified.

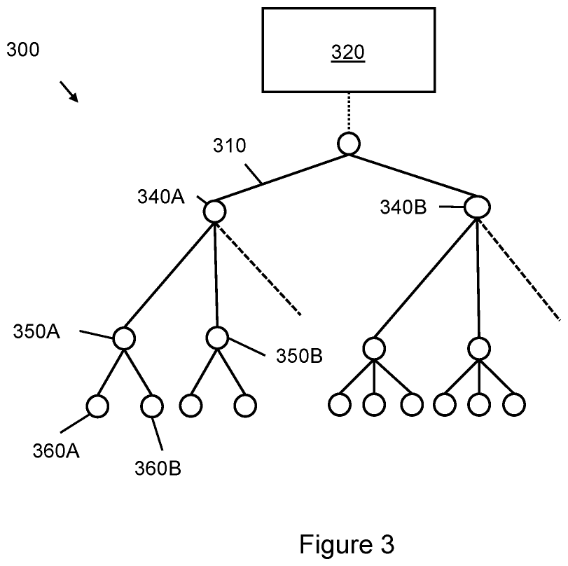

FIG. 3 is a schematic diagram showing a workflow template data structure 300, according to an example. In the example 300 shown in FIG. 3, the state of the secure ledger is represented by an addressed tree-like structure 310 such as Merkle trees or Radix trees. The block 320 is the most current block of the secure ledger. Associated to the block 320 is the root of the tree 330, which is the ledger state tree root. Typically, this is a hash value that is computed, based on the hash values associated to workflow instances.

Subtrees 340A, 340B of the state tree 310 are associated with particular types of real workflows. Subtree 340A is associated with workflow A and subtree 340B is associated with a second workflow, workflow B. Nodes 350A and 350B that are connected to node 340A correspond to workflow instances of the type A workflow associated to node 340A. The leaf nodes 360A, 360B that are connected to the node 350A correspond to transactions of the workflow instance corresponding to node 340A.

In the example shown in FIG. 3, the assignment of workflow instances to nodes of the tree 310 is performed by, for example, the workflow template manager 170 shown in FIG. 1.

During an initiation phase, the workflow templates 300 are defined. In this phase the state of the secure ledger state is divided in the tree like structure 310 shown in FIG. 3. For all workflow subtrees 340, all possible workflow instances are mapped on to the child nodes 350. The subtree template corresponding to each workflow is created to reflect ordering and state transitions of the corresponding workflow transactions which are represented as the leaf nodes 360 in the tree 310.

Each workflow instance is stored in a pre-computable and unique place of the tree 310 using a unique identity. This identity may be computed using the initial portion of a hash function output, that is known to the participants who are involved. According to examples described herein, append and sequential writing rules may be used to determine addresses of child nodes for each workflow instance. This means that data that is stored in addresses that have been assigned to nodes in a deterministic manner.

Once the workflow and workflow instances are uniquely assigned addresses in the tree 310 a smart contract, or any other application able to write to the ledger state is set to enforce workflow rules and write updates to the state according to the addresses and workflow templates defined in the tree 310.

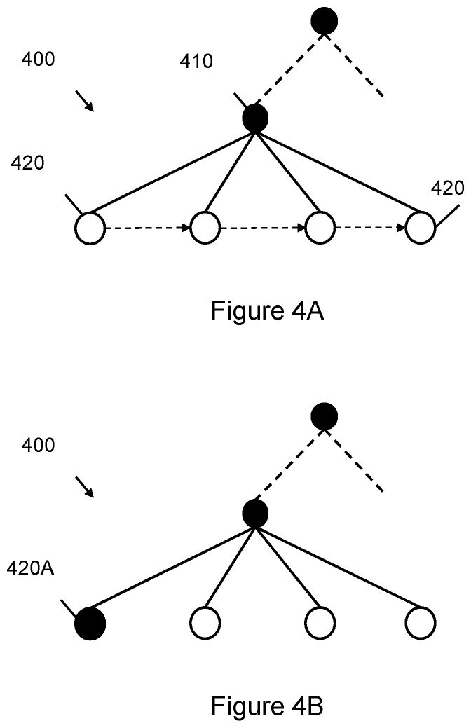

FIG. 4 is a schematic diagram showing an initial state 400 of a workflow instance, according to an example. In the example shown in FIG. 4, the Workflow Instance 1 (WI₁) is represented by a subtree 410 of the state. Every transaction of the workflow instance WI₁ is then identified, respecting ordering, by a leaf of the subtree 410.

In the example, the workflow instance is constituted of four transactions 420. These transactions are expected to happen in this order and no transactions can be skipped. Whenever data representing a transaction is sent to the ledger, it is written to the corresponding leaf assuming that the workflow rules are respected.

Initially, the workflow instance subtree 410 is empty, as shown in FIG. 4, by the empty circles of the leaf nodes 420. When the first transaction of the workflow instance is performed, data is sent to the ledger and the corresponding leaf node is populated with data to be recorded in the ledger. This is shown in FIG. 4B. The node 420A, is now populated.

The same applies for the second, third and fourth transactions of the workflow instance WI₁. The subtree 410 is sequentially populated, like an array, enforcing the rule that two sequential events are consecutively stored in the subtree 410.

To avoid parallel histories, the location of the workflow instance 410 within the overall tree has to be deterministic and unique. This is achieved using, for example a function such as:

ƒ(ID of WI₁)=45ac8b

Here, 45ac8b is an address that is computed using the function ƒ. The function ƒ can be a hash function, for example.

To enforce uniqueness of ƒ, it is publicly available in a way that any change to the function would be spotted by any querying parties. This could be done for example by including ƒ, or a fingerprint of ƒ, within all block headers of the secure ledger, such that the function may not be altered from one block to the next. A new block N would then be valid if ƒ has not been modified:

Block_{N-1}(ƒ)=Block_{N}(ƒ)

That is to say if ƒ is the same within block N−1 than within block N.

Workflow transactions 420 can also be given fixed addresses, so that a transaction can be written to one position in the subtree 410. For example: the first transaction represented by node 420A may be given the address 45ac8b1, the second transaction address 45ac8b2 and so on. That way, any missing transaction leaves a blank in the subtree 410 revealing incompleteness of the information. Placing a transaction into the wrong leaf 420 will be spotted when the ledger is queried by the client.

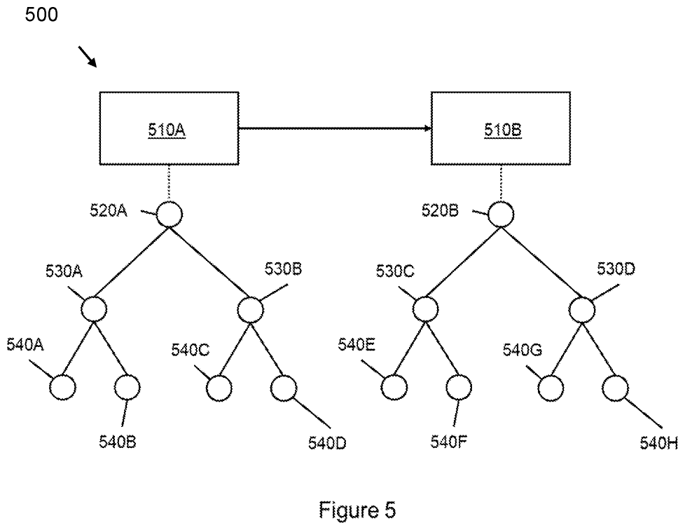

FIG. 5 is a schematic diagram showing an example of a workflow template data structure 500 over time between two blocks 510A and 510B of a secure ledger. The block 510B is the last block on the secure ledger. Hash values of the node 520A are stored in block 510A to ensure the immutability of the content of leaves 540A, 540B, 540C and 540D. Similarly, the hash value of node 520B is stored in block 510B to ensure the immutability of the content of leaves 540E, 540F, 540G and 540H.

The data structure in FIG. 5 is a Merkle tree. A Merkle tree is a tree of hash values. Merkle proofs may be used to establish properties of data in the Merkle tree. Merkle proofs are proofs that demonstrate validity of data, that data belongs to the tree and that data is part of a data set. A Merkle proof may be used to prove that leaf 540B is in block 510A by proving:

H_{530A}=H(H_{540A}+H_{540B})

H_{520A}=H(H_{530A}+H_{530B})

In examples described herein the verification data that is communicated in response to a query prevents the three attack scenarios previously described, namely, an attack based on switching blocks at the last minute, generating parallel histories, or presenting alternate histories based on earlier blocks.

As an example, suppose the client wants to query the second step of the workflow instance 540B. Querying the second step of the workflow instance 530B is equivalent to querying the content of 540F. To prevent block switching the client is presented with a proof of consistency that demonstrates that the values stored at nodes 540B and 540F are the same. The client also needs a proof that the content of node 540F has not subsequently been changed since it was written in to. The client is presented with a proof that the node was empty until the point it was written in to prevent an adversary presenting parallel or alternate histories for the nodes 540B and 540F. This is equivalent to proving that the nodes were written into once.

As an example, a proof of consistency that demonstrates that the values stored at nodes 540B and 540F are the same is as follows. Suppose that the content C of leaf 540B was not modified is equivalent to generate verification data comprising proofs of three statements, namely:

H(C)=H_{540B}=H_{540F}

### A proof that leaf 540B is in block 510A

### A proof that leaf 540F is in block 510B

The proof that leaf 540B is in block 510A is a proof that:

H_{530A}=H(H_{540A}+H_{540B})

H_{520A}=H(H_{530A}+H_{530B})

The verification data is recursively generated for consecutive blocks to prove that a workflow stage has not been modified over a sequence of blocks of arbitrary length.

If a client wants to query any stage of a workflow instance, for example 540B, while knowing the latest hash value stored in the secure ledger, they can also request the proof that this result is valid. Such a proof is produced as follows. Suppose the following order of events has occurred: let the first block of the secure ledger be referred to as the genesis block, G. The first transaction of a workflow instance which comprises two transactions occurs at the N₁'th block. The second transaction occurs at the N₂'th block. N₁ and N₂ are integers with N₂>N₁.

The proof associated with a query on the second stage of the workflow then consists of: a proof that the leftmost leaf node was empty, a proof that the leftmost leaf node was not modified between blocks 0 and N₂−1, a proof of the content of the leftmost leaf node at block N₂, a proof that the leftmost leaf node was not modified between blocks N₂+1 and the current block.

In this example, some proofs are implicit. For example, including proofs that check that previous transactions have not been modified in blocks where a new transaction is added and that a new transaction is written consecutively to its previous transaction. That is to say, proofs that verify that the order of execution of transaction is correct. The state tree and addresses can be defined and computed in a way which facilitates the proofs.

The proofs described herein grow linearly with the size of the secure ledger, because they consist of proving the following statements: proof that a node value has not changed between block N₂+1 and block N₂+2, proof that node value has not changed between block N₂+2 and block N₂+3, and so on until the current block. The methods described herein may further utilise cryptographic arguments of knowledge to provide succinct proofs of statements. This allows the proofs to be compressed prior to communicating the proofs to the client. Proof can also be optimized for proving all stages of a workflow instance at the same time.

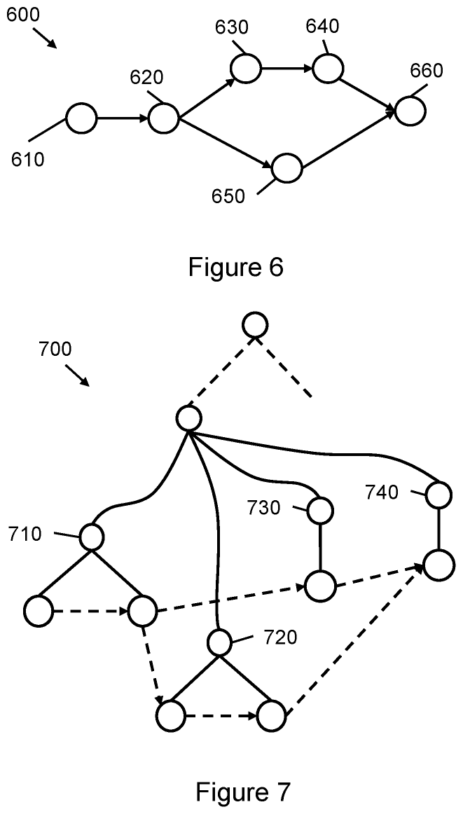

FIG. 6 is a simplified schematic diagram that shows a workflow 600 according to an example. In FIG. 6 there is shown an example of a workflow 600 which comprises two branches. In the workflow 600, following the second transaction 620, the workflow 600 can follow one of two independent sequence of transactions. Either the workflow can proceed with transaction 650, or the transactions 630 and 640. Both paths finish with the same transaction 660.

FIG. 7 is a simplified schematic diagram that shows a workflow template according to an example. The workflow 600 is encoded in the workflow template 700 shown in FIG. 7. The workflow template comprises subtrees 710, 720, 730, 740.

Each subtree in FIG. 7 corresponds to a sub-path of the workflow 600. In particular, the leaf nodes of subtree 710 corresponds to workflow transactions 610 and 620. The leaf nodes of subtree 720 corresponds to workflow transactions 630 and 640. The single leaf node of the subtree 730 corresponds to workflow transaction 650 and finally the leaf node of the subtree 740 corresponds to the workflow transaction 660.

In the example shown in FIG. 7, to verify the validity of the workflow, the verification data includes proofs that: the subtrees 710, 720, 730, 740 are filled sequentially, if subtree 720 is non-empty, then subtree 730 is empty and if subtree 720 is empty, then subtree 730 is non-empty or that subtrees 730 and 740 must be empty. This corresponds to the fact that in the workflow 600 either neither one of the sub-paths corresponding to transactions 630, 640 or 650 were executed, or exactly one of the sub-paths have been executed.

Similar logic can be applied to produce rules for proofs for any workflow represented as an acyclic ordered graph similar to the workflow 600 shown in FIG. 6.

The methods and systems described herein allow the whole history of a workflow instance to be queried in a single block while maintaining the confidentiality of other workflow instances. This is because the content of the secure ledger is not needed to compute the proofs. In particular the methods and systems described herein allow a querying client to receive a proof of integrity, uniqueness and completeness without having to run the secure ledger themselves and without getting any information about other entries of the secure ledger.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

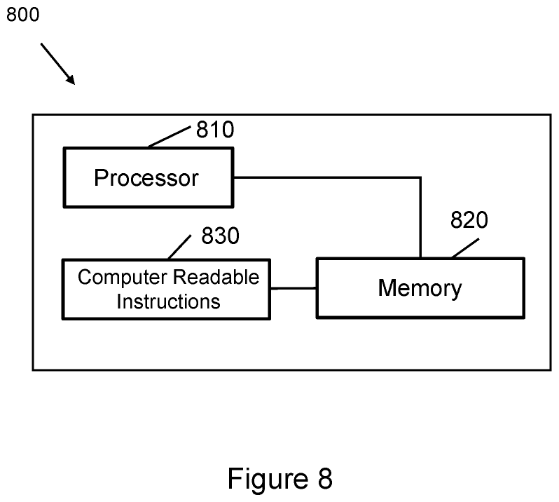

For example, the instructions may be provided on a non-transitory computer readable storage medium encoded with instructions, executable by a processor. FIG. 8 shows an example of a processor 810 associated with a memory 820. The memory 820 comprises computer readable instructions 830 which are executable by the processor 810. According to examples, processor 800 is the query processor 130 of FIG. 1.

The instructions 830 comprise instruction to determine the secure ledger in response to a request to confirm a transaction of a workflow has occurred, the workflow specifying a series of transactions and execution order of transactions, generate attestation data on the basis of secure ledger data of the secure ledger, the attestation data attesting that the transaction has occurred in accordance with the workflow and send the attestation data to the client wherein the workflow is encoded as a workflow template in the secure ledger, such that each transaction of the workflow references a corresponding entry of the workflow template, and the secure ledger is determined on the basis of transactions of the workflow being executed.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for certifying transactions of a workflow for a workflow comprising a set of transactions and a permitted order of execution of transactions, the method comprising:
deriving verification data from a secure ledger in response to a request from a client to certify a transaction of the workflow, the verification data certifying the validity of the secure ledger; and
communicating the verification data to the client;
wherein the secure ledger is computed on the basis of workflow transactions.

2. The method of claim 1, wherein the workflow is encoded as a workflow template data structure in the secure ledger, such that each transaction of the workflow is assigned a pre-determined entry in the workflow template data structure.

3. The method of claim 2, comprising:
computing an initial entry to the secure ledger as a function of an input associated to the creation of the workflow.

4. The method of claim 2, wherein the workflow template data structure comprises a tree wherein each transaction of the workflow is assigned a leaf node, and wherein the secure ledger is determined as a function of values assigned to the leaf nodes.

5. The method of claim 4, comprising writing data to a leaf node in response to execution of a transaction in the workflow.

6. The method of claim 4, wherein the verification data is derived on the basis of the values assigned to the nodes of the tree.

7. The method of claim 1, wherein deriving verification data on the basis of the secure ledger, comprises:
generating verification data certifying the validity of the secure ledger for the state of the secure ledger before, during and/or after the transaction.

8. The method of claim 1, wherein the secure ledger comprises a secure hash of state data associated to the workflow.

9. The method of claim 1, comprising
receiving verification data in response to a query; and
verifying the validity of the of the secure ledger on the basis of the verification data.

10. The method of claim 9, wherein verifying the validity of the secure ledger comprises at least one of:
verifying a cryptographic proof of knowledge asserting properties of the secure ledger;
recomputing the secure ledger; and
comparing recomputed values to secure ledger communicated with the verification data.

11. The method of claim 1, wherein the verification data is derived on the basis of further data in addition to the secure ledger.

12. An apparatus comprising:
a data storage arranged to store a secure ledger, the secure ledger comprising a record of a history of transactions of a workflow instance;
a workflow controller communicatively coupled to the data storage, arranged to update the secure ledger on the basis of transactions executed in the workflow instance; and
a query processor communicatively coupled to the data storage, arranged to:
process queries relating to transactions of the workflow instance;
generate query responses on the basis of the secure ledger; and
communicate the query responses in response to queries.

13. The apparatus of claim 12 comprising a workflow template manager communicatively coupled to the data storage and workflow controller, arranged to:
generate a workflow template data structure for a workflow that encodes workflow instances to a secure ledger.

14. The apparatus of claim 11, wherein the size of the data communicated as a query response is smaller than the size of the secure ledger.

15. A non-transitory machine-readable storage medium encoded with instructions executable by a processor to:
determine ledger data stored in a secure ledger in response to a request to confirm a transaction of a workflow has occurred, the workflow specifying a series of transactions and execution order of transactions;
generate attestation data on the basis of ledger data of the secure ledger, the attestation data attesting that the transaction has occurred in accordance with the workflow; and
send the attestation data to the client;
wherein the workflow is encoded as a workflow template in the secure ledger, such that each transaction of the workflow references a corresponding entry of the workflow template, and the ledger data of the secure ledger is determined on the basis of transactions of the workflow being executed.
